(19) United States
(12) Patent Application Publication
(10) Pub. No.: US 2009/0089831 A1
(43) Pub. Date: Apr. 2, 2009

(54) Method and Apparatus for Pop Screen Dialog for Roving Devices With Terrestrial Broadcast Receiver

(76) Inventor: Thomas James Woch, Los Altos, CA (US)

Correspondence Address: Robert D. Shedd;Thomson Licensing LLC, PO Box 5312, PRINCETON, NJ, 08543-5312, US

(21) Appl. No.: 11/990,406

(22) PCT Filed: Aug. 24, 2006
(86) PCT No.: PCT/US2006/033160

§ 371 Date: Feb. 13, 2008

Related U.S. Application Data
(60) Provisional application No. 60/710,830, filed on Aug. 24, 2005.

(51) Int. Cl. H04N 7/025

(52) U.S. Cl. 725/35

(57) ABSTRACT

There are provided a method and apparatus for generating pop screen dialog for roving devices with a terrestrial broadcast receiver. The apparatus includes a dialog generator (110) for generating dialog messages related to operations of a mobile device having a terrestrial receiver that receives digital terrestrial signals. The dialog messages are automatically generated without user prompting.

### CROSS-REFERENCE TO RELATED APPLICATIONS

This application claims the benefit of U.S. Provisional Application Ser. No. 60/710,830, filed Aug. 24, 2005, which is incorporated by reference herein in its entirety.

### TECHNICAL FIELD

The present principles relate generally to mobile devices and, more particularly, to a method and apparatus for generating pop screen dialog for mobile devices with a terrestrial broadcast receiver.

### BACKGROUND

New portable video devices having a Digital Video Broadcast-Terrestrial (DVB-T) tuner are constantly being introduced. Such devices display video broadcasts emanating from land-based digital transmitters. The roving nature of such devices makes the situation unique from traditional analog or digital television. When a user takes this device in a car or on a train, he may travel outside the area of transmission and into a new are of transmission. However, the user may be unaware of the changed situation and also may be unaware of what steps may be taken to deal with the changed situation in a desirable manner.

### SUMMARY

These and other drawbacks and disadvantages of the prior art are addressed by the present principles, which are directed to a method and apparatus for generating pop screen dialog for mobile devices with a terrestrial broadcast receiver.

According to an aspect of the present principles, there is provided an apparatus. The apparatus includes a dialog generator for generating dialog messages related to operations of a mobile device having a terrestrial receiver that receives digital terrestrial signals. The dialog messages are automatically generated without user prompting.

According to another aspect of the present principles, there is provided a method. The method includes generating dialog messages related to operations of a mobile device having a terrestrial receiver that receives digital terrestrial signals. The dialog messages are automatically generated without user prompting.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an exemplary apparatus for generating pop screen dialog for a mobile device with a terrestrial broadcast receiver, in accordance with an embodiment of the present principles;

FIG. 2 is a screen shot of an exemplary start up display screen having a pop up message for use when initializing a mobile device, in accordance with an embodiment of the present principles;

FIG. 3 is a screen shot of an exemplary display screen having a fixed background pop up message with an attention icon, in accordance with an embodiment of the present principles;

FIG. 4 is a screen shot of an exemplary display screen having a pop up message with an information icon, in accordance with an embodiment of the present principles;

FIGS. 5A-E are screen shots of various exemplary display screens having pop up messages from one to five lines, respectively, in accordance with an embodiment of the present principles; and

FIG. 6 is a flow diagram for an exemplary method for generating pop up dialog messages for a mobile device with a terrestrial broadcast receiver, in accordance with an embodiment of the present principles.

### DETAILED DESCRIPTION

The present principles are directed to a method and apparatus for generating pop screen dialog for mobile devices with a terrestrial broadcast receiver.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

As noted above, the present principles are directed to a method and apparatus for pop dialog screen for roving devices with a terrestrial broadcast receiver. Advantageously, implementations in accordance with the present principles may be configured to generate dialog without user prompting, so that a user may be made aware of a changed condition (e.g., roving outside a primary transmission area) by an automatic indication via a pop dialog without having to explicitly engage the system to obtain such indication.

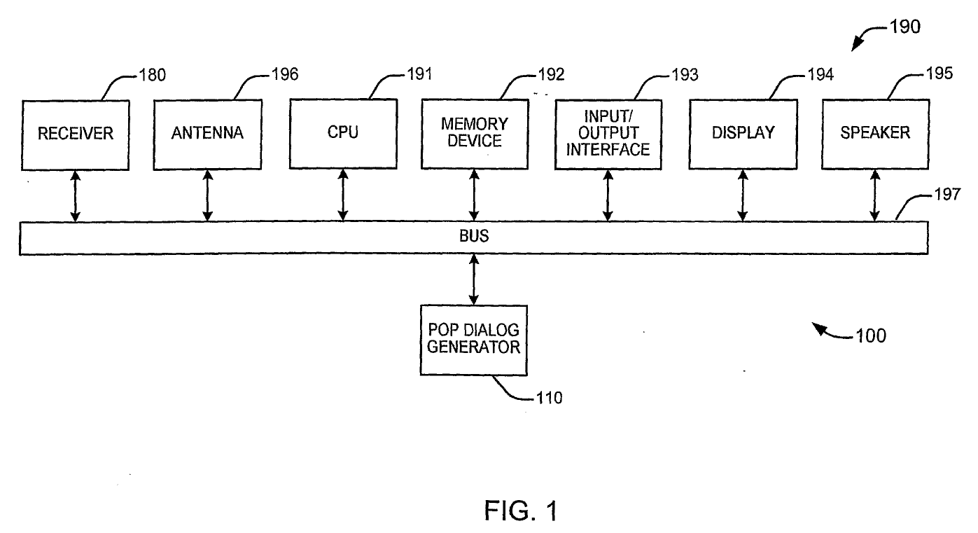

Turning to FIG. 1, an exemplary apparatus for generating pop screen dialog for a mobile device with a terrestrial broadcast receiver is indicated generally by the reference numeral 100.

The apparatus 100 is incorporated into a mobile device 190. For the sake of brevity, a brief description of the mobile device 190 is provided. However, one of ordinary skill in this and related arts will contemplate the following and other elements and implementations of a mobile device to which the present principles may be applied, while maintaining the scope of the present principles. The mobile device 190 includes a processor 191, at least one memory device 192, an input/output interface 193, a display 194, at least one speaker 195, at least one receiver 180, and an antenna 196. Bus 197 interconnects the preceding elements of the mobile device 190.

The processor 191 may be, e.g., a digital signal processor, or may include a digital signal processing portion, for processing digital signals such as audio and video signals. Accordingly, any of the processor 191 and one or more of the at least one receiver 180 may include corresponding elements or circuitry for performing signal processing including, but not limited to, signal reception, demodulation, and so forth. Such elements and circuitry may include, e.g., digital-to-analog converters (DACs), tuners, and so forth.

The apparatus 100 includes a pop dialog generator 110. Bus 197 also connects the pop dialog generator 110 to the elements of the mobile device 190.

The pop dialog generator 110 generates pop dialog for a user of the mobile device 190. Such dialog may relate to making the user aware of a changed situation (e.g., out of primary transmission area) and to dealing with the changed situation in a desirable manner.

It is to be appreciated that while the pop dialog generator 110 is shown as a separate element from those described as part of the mobile device 190, one of ordinary skill in this and related arts can appreciate that one or more existing components of the mobile device 190 may also be used to implement an apparatus for generating pop dialog for a mobile device in accordance with the present principles while maintaining the scope of the present principles. For example, the apparatus 100 may use one or more existing elements of the mobile device 190 to implement the present principles. Such existing devices may include, but are not limited to, the processor 191 and the at least one memory device 192.

Input to the pop dialog generator 110 may be provided from one or more of the other elements of the mobile device 190. For example, the processor 191 may provide an indication of a weak or unavailable signal, an inability to tune to a particular program, an out-of-network condition, and so forth, to the pop dialog generator 110 to allow the pop dialog generator 110 to generate an appropriate message for display to a user. Types of situations/conditions which may prompt the generation of a pop dialog message in accordance with the present principles are described in further detail herein below. Messages may be formatted for display by the pop dialog generator 110 itself, the processor 191, and/or by the display 194 and corresponding circuitry (e.g., a video adapter (not shown)).

The present principles are directed to a method and apparatus for pop dialog screen for roving devices with a terrestrial broadcast receiver. In accordance with an embodiment of the present principles, dialog messages are provides to a user of a roving device with a terrestrial broadcast receiver. The dialog messages may be generated to be unique to the roving device of the user.

The present principles may be used, for example, in a roving device with a Digital Video Broadcast-Terrestrial (DVB-T) receiver such as, for example, MobiliTV or iZiGO. Such a device displays video broadcasts emanating from land-based digital transmitters. The roving nature of this device makes the situation unique from traditional analog or digital television. When a user takes this device in a car or on a train, he/she may travel outside the area of transmission and into a new area of transmission. The dialog messages may be configured to allow users to understand this situation and make satisfactory changes to ensure optimum satisfaction with the device.

It is to be appreciated that while the present invention is primarily described with respect to a roving device with a DVB-T receiver, the present principles may be readily applied to other roving devices. That is, given the teachings of the present principles provided herein, one of ordinary skill in this and related arts will contemplate these and other roving devices to which the present principles may be applied while maintaining the scope of the present principles.

The dialog messages provided herein in accordance with various embodiments of the present principles may be displayed while the software is functioning, may be generated based on a text string, and may have a video background or a fixed background.

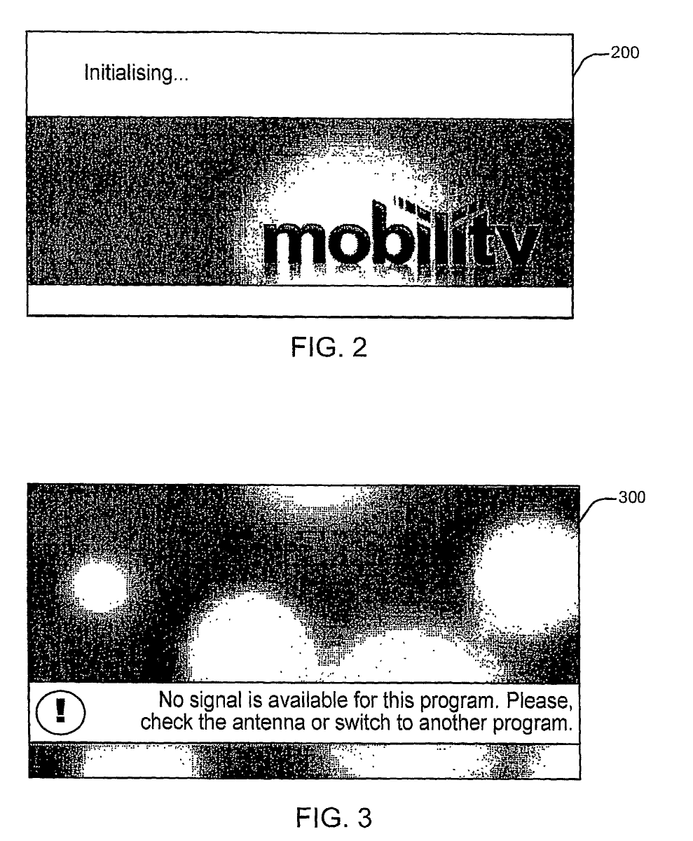

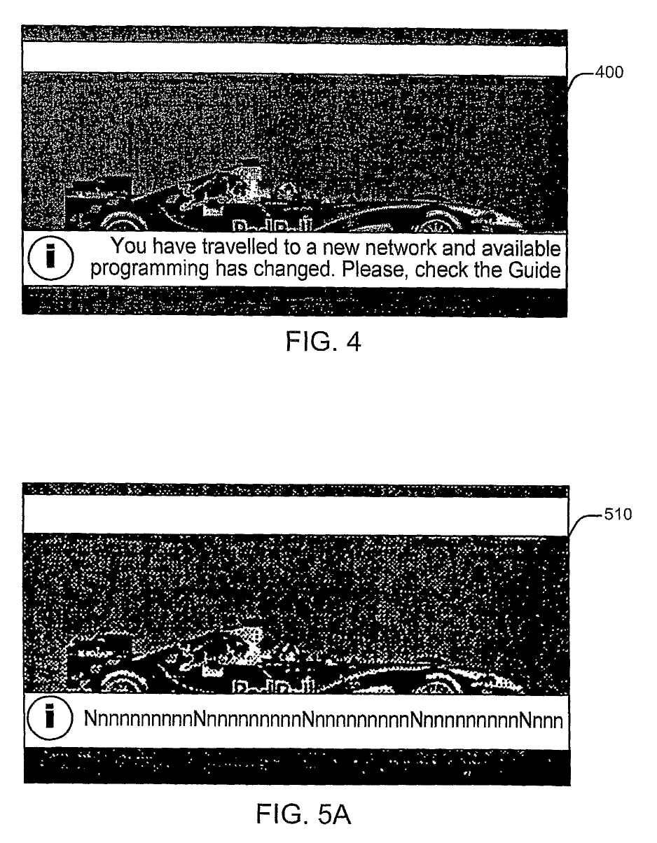

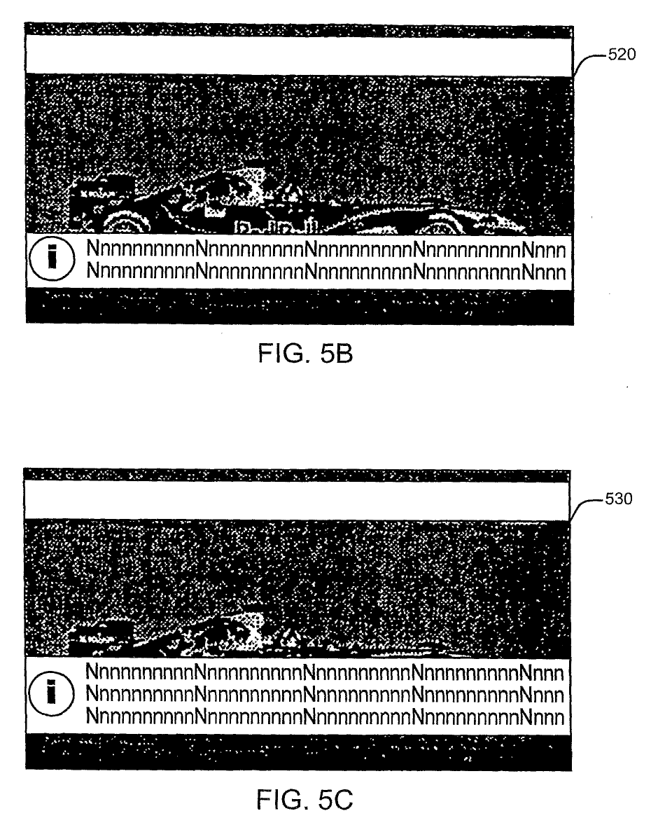

Turning to FIG. 2, a screen shot of an exemplary start up display screen having a pop up message for use when initializing a mobile device is indicated generally by the reference numeral 200. Turning to FIG. 3, a screen shot of an exemplary display screen having a fixed background pop up message with an attention icon is indicated generally by the reference numeral 300. Turning to FIG. 4, a screen shot of an exemplary display screen having a pop up message with an information icon is indicated generally by the reference numeral 400. Various uses of the USB icon, the attention icon, and the information icon are described herein below with respect to various types of messages generated in accordance with the present principles.

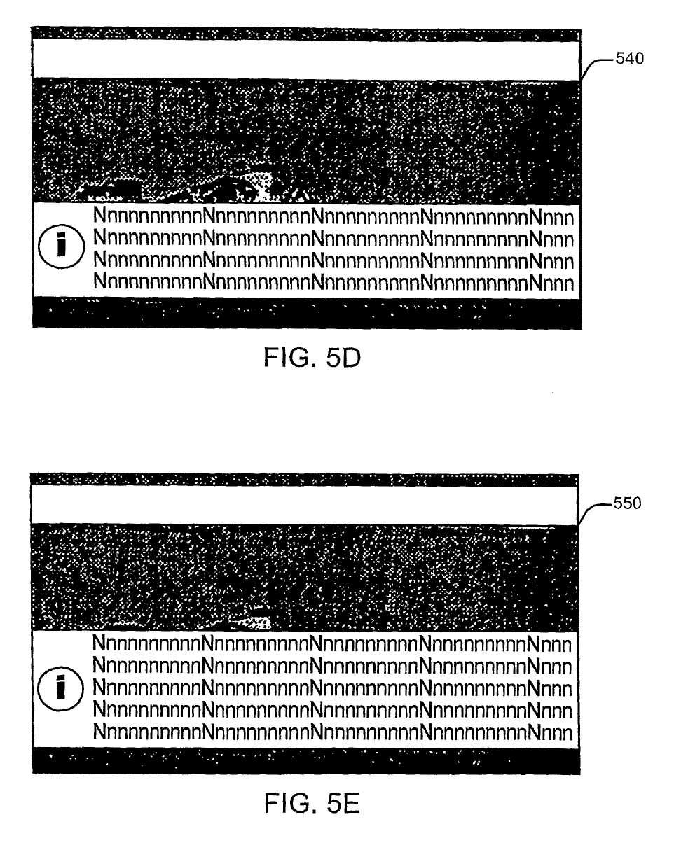

Turning to FIGS. 5A-E, various screen shots of various exemplary display screens having pop up messages from one to five lines, respectively, are indicated generally by the reference numerals 510, 520, 530, 540, and 550, respectively. The various screen shots illustrate the amount of overlap with respect to a current message being shown and a background image.

In an embodiment of the present principles, an icon referred to as “USB”, having the following text “Initializing. Please wait . . . ” may be displayed in the following situations: when the unit is powered on the very first time; the NVRAM and Flash File System are corrupted, re-initialized and all history is lost; the middleware is trying to tune to the last known service; and during power-up, the middleware detects that it can tune to a saved-service. This message indicates the user needs to be patient and wait for the initialization to complete. This message may come up over a blank screen or still image and may persist until the task is completed. If the task fails, a message may be shown indicating there is no signal.

In an embodiment of the present principles, an icon referred to as “INFO”, having the following text “Searching for Signal . . . ”, may be displayed whenever the middleware decides to abandon what it is doing because none of its cached services or tuning parameters appear to be valid, and it needs to search to see what is really there by calling simob scan( ). The SIMob module is a module on a Set Top Box (STB) that scans the service information from a Digital Video Broadcast (DVB) signal. After tuning to a terrestrial signal, the resultant demodulated digital data stream includes both audio/video content and data segments. The data segments include programming information about the names of programs, services, and content and how they can be decoded from the audio/video part of the stream. The simob_scan( ) in the SIMob performs this scanning operation on the data stream. Until SIMob obtains the information for how to play the stream, no audio/video programming can be played and the “Searching for Signal . . . ” text is displayed. This should normally occur under the following circumstances: following the “Initializing . . . ” screen when the unit has no history; after the SIMob module has informed the middleware that it has lost the requested service (“lock_lost”) and has no place to go; and when the user selects “Manual Tune” from the settings. This message may appear over a blank screen or still image and may persist until the task is complete or no programming was found. This message indicates to the user that the unit is scanning for TV signals but there is nothing the user needs to do. If no programming was found, a message may be shown indicating there is no signal.

In an embodiment of the present principles, an icon referred to as “INFO”, having the following text “Scanning for Programs . . . ” may be displayed whenever the middleware is doing a simob_scan( ) and trying to rebuild its service table. Since the middleware is always scanning for services, this screen is preferably only shown in the situation where it knows that no audio/video is playing and has actually called simob_scan( ). This message may appear over a blank screen or still image and may persist until programs are found. This message indicates to the user that TV signals have been found and the unit is searching for playable programs. If no programs are found, then a message may be displayed indicating no signal.

In an embodiment of the present principles, an icon referred to as “ATTENTION”, having the following text “No signal is available for this program. Please check the antenna or switch to another program” may be displayed when service is lost, but there are other services on the same network available. By definition, any playing audio/video or Multimedia and Hypermedia information coding Expert Group (MHEG) application has stopped. Therefore, the screen can appear over a still image. This message informs a user that the signal for the current program has been lost, but the user has not lost all signals for all channels in their current network. This message may persist until the user changes the program or the signal is restored.

In an embodiment of the present principles, an icon referred to as “ATTENTION”, having the following text “No signal. Please check the antenna or move to a different location” may be displayed when the signal for the service is lost completely and no other signals are available. For example, a person tries to use the device in a tunnel or a cave. This is analogous to removing the antenna from a terrestrial set top box (STB) or the satellite feed from a satellite STB. This message may persist until signal is restored.

In an embodiment of the present principles, an icon referred to as “INFO”, having the following text “You have traveled to a new network and available programming has changed. Please check the Guide.” This screen is displayed when traveling from one network to a new network or may be displayed when the device is turned on after having traveled to a new network, provided that the new network has additional services or fewer services than the previous network. If the device is in an Intra-Network switch where the service offering does not change at all, this screen would not appear. This screen may appear over the current video, menu, or guide. This message may appear for a period of time.

In an embodiment of the present principles, an icon referred to as “INFO”, having the following text “You have traveled to a new network, and the current program signal is no longer available. Attempting to switch to similar programming . . . ” may be displayed when the device has traveled to a new network while a user is watching a program, and the same LCN is available in the new network, but it is not exactly the same program. For example, BBC 1 London versus BBC 1 Ulster. This screen may appear over the current video, menu, or guide. This message may appear for a period of time. At the end of that time, the device tunes to the LCN on the new network.

In an embodiment of the present principles, an icon referred to as “ATTENTION”, having the following text “You have traveled to a new network, and the current program is no longer available. You may select new program from the Guide.” may be displayed when the device has traveled to a new network while a user is watching a program, and the LCN is not available in the new network. The message appears after the middleware has lost the signal or that signal suffers significant problems such that viewing becomes impossible. This screen may appear over the current video, menu, or guide. This message persists until the user switches channels or goes to a guide or menu.

In an embodiment of the present principles, an icon referred to as “USB”, having the following text “Would you like to upgrade your software? Press MENU to start upgrade. Press any other button to quit.” may be displayed when the middleware gets notification that the USB has been attached. Any other interactive screen such as the Guide or any menu should be exited. This message may appear over a blank screen or still image, or playing audio/video and may require user input. This message may persist until the user responds or disconnects the USB cable.

In an embodiment of the present principles, an icon referred to as “USB”, having the text “Downloading. Do not unplug the USB cable. Please wait . . . ” may be displayed when the user has chosen to continue with the upgrade process, and the Middleware should call reboot( ) from the power manager. This message may persist until the download is complete. If the download fails, then the download failure message may appear.

In an embodiment of the present principles, an icon referred to as “ATTENTION”, having the text “Download failed. Please try again.” may be displayed.

In an embodiment of the present principles, an icon referred to as “USB”, having the text “Download complete. Please unplug the USB cable.” may be displayed once when downloading is complete. This message may persist until the USB cable is unplugged. Once unplugged, the middleware should go back to playing the program of the most recently tuned LCN. If that LCN is not available, then the device may tune to the lowest numeric LCN. This is analogous to turning the unit ON from an OFF state.

In an embodiment of the present principles, an icon referred to as “USB”, having the following text “Please unplug the USB cable.” may be displayed when the user has chosen not to continue with the download process. This message may persist until the user unplugs the USB cable. Once unplugged, the middleware should go back to simply playing the previously known program. If previously in a menu or guide, then a return is made to a program and not the menu or guide.

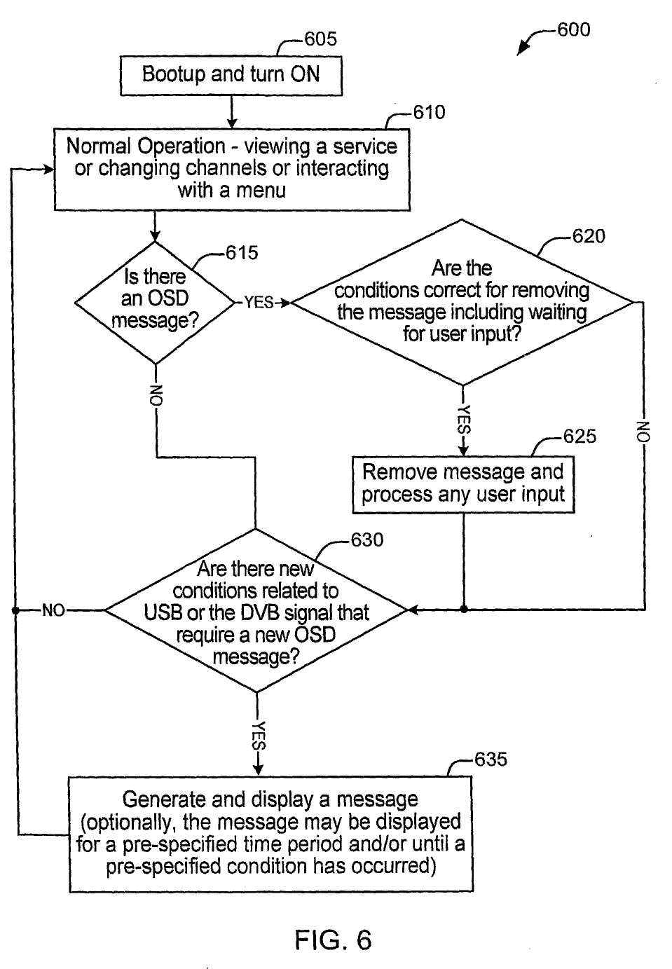

Turning to FIG. 6, a flow diagram for a method for generating pop up dialog messages for a mobile device with a terrestrial broadcast receiver is indicated generally by the reference numeral 600.

The method 600 includes a function block 605 that boots up and turns on the mobile device, and passes control to a function block 610. The function block 610 performs a normal operation (e.g., viewing a service, changing channels, interacting with a menu, and so forth), and passes control to a decision block 615. The decision block 615 determines whether or not there is an On Screen Display (OSD) message. If so, then control is passed to a decision block 620. Otherwise, control is passed to a decision block 630.

The decision block 620 determines whether or not the conditions are correct for removing the message including waiting for a user input. If so, then control is passed to a function block 625. Otherwise, control is passed to a decision block 630.

The function block 625 removes the message, processes any user input, and passes control to the decision block 630.

The decision block 630 determines whether or not there are any new conditions related to Universal Serial Bus (USB) or the Digital Video Broadcast (DVB) signal that require a new message. If so, then control is passed to a function block 635. Otherwise, control is returned to the function block 610.

The function block 635 generates and display the new message, and returns control to the function block 610. Regarding function block 635, the message may optionally be displayed for a pre-specified time period and/or until a pre-specified condition has occurred. The pre-specified condition may involve, e.g., receiving a user input. Of course, the present principles are not limited to solely the receipt of a user input as the pre-specified condition and, thus, other pre-specified conditions may also be utilized for determining how long to display a message in accordance with the present principles, while maintaining the scope of the present principles.

A description will now be given of some of the many attendant advantages/features of the present invention, some of which have been mentioned above. For example, one advantage/feature is an apparatus that includes a dialog generator for generating dialog messages related to operations of a mobile device having a terrestrial receiver that receives digital terrestrial signals. The dialog messages are automatically generated without user prompting.

Another advantage/feature is the apparatus as described above, wherein at least one of the dialog messages relates to a problem suffered by the mobile device in receiving a digital terrestrial signal.

Yet another advantage/feature is the apparatus as described above, wherein the mobile device is a digital mobile television.

Moreover, another advantage/feature is the apparatus as described above, wherein the dialog messages correspond to digital television functions.

Further, another advantage/feature is the apparatus as described above, wherein at least one of the dialog messages is represented by at least one of an icon and a text string.

Also, another advantage/feature is the apparatus as described above, wherein various ones of the dialog messages are differentiated based on various purposes, the various purposes being represented by various displayed icons.

Additionally, another advantage/feature is the apparatus as described above, wherein at least one of the dialog messages at least one of indicates a current operating condition to a user of the mobile device or requests an input from the user regarding the current operating condition.

Moreover, another advantage/feature is the apparatus as described above, wherein at least one of the dialog messages relates to at least one of an initialization of the mobile device, an absence of a requested service, an absence of a signal, an absence of a selected program, an out-of-network condition, an available upgrade to the mobile device, a download status, and a request for user action relating to an operation of the mobile device.

Further, another advantage/feature is the apparatus as described above, wherein at least one of the dialog messages relates to informing a user of a current undesired status of a digital television function and at least another one of the dialog messages relates to informing the user of a user action for changing the current undesired status back to a previous desired status.

Also, another advantage/feature is the apparatus as described above, wherein at least one of the dialog messages is configured for display at least one of over a pre-specified time period and until a pre-specified condition has occurred.

Additionally, another advantage/feature is the apparatus as described above, wherein the pre-specified condition comprises a receipt of a user input.

Moreover, another advantage/feature is the apparatus as described above, wherein at least one of the dialog messages is configured for display over an existing image, a particular image dedicated for use with the at least one of the dialog messages, a fixed image, and a dynamic image.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a dialog generator for generating dialog messages related to operations of a mobile device having a terrestrial receiver that receives digital terrestrial signals,
wherein the dialog messages are automatically generated without user prompting.

2. The apparatus of claim 1, wherein at least one of the dialog messages relates to a problem suffered by the mobile device in receiving a digital terrestrial signal.

3. The apparatus of claim 1, wherein the mobile device is a digital mobile television.

4. The apparatus of claim 3, wherein the dialog messages correspond to digital television functions.

5. The apparatus of claim 1, wherein at least one of the dialog messages is represented by at least one of an icon and a text string.

6. The apparatus of claim 5, wherein various ones of the dialog messages are differentiated based on various purposes, the various purposes being represented by various displayed icons.

7. The apparatus of claim 1, wherein at least one of the dialog messages at least one of indicates a current operating condition to a user of the mobile device or requests an input from the user regarding the current operating condition.

8. The apparatus of claim 1, wherein at least one of the dialog messages relates to at least one of an initialization of the mobile device, an absence of a requested service, an absence of a signal, an absence of a selected program, an out-of-network condition, an available upgrade to the mobile device, a download status, and a request for user action relating to an operation of the mobile device.

9. The apparatus of claim 1, wherein at least one of the dialog messages relates to informing a user of a current undesired status of a digital television function and at least another one of the dialog messages relates to informing the user of a user action for changing the current undesired status back to a previous desired status.

10. The apparatus of claim 1, wherein at least one of the dialog messages is configured for display at least one of over a pre-specified time period and until a pre-specified condition has occurred.

11. The apparatus of claim 10, wherein the pre-specified condition comprises a receipt of a user input.

12. The apparatus of claim 1, wherein at least one of the dialog messages is configured for display over an existing image, a particular image dedicated for use with the at least one of the dialog messages, a fixed image, and a dynamic image.

13. A method, comprising:
generating dialog messages related to operations of a mobile device having a terrestrial receiver that receives digital terrestrial signals,
wherein the dialog messages are automatically generated without user prompting.

14. The method of claim 13, wherein at least one of the dialog messages relates to a problem suffered by the mobile device in receiving a digital terrestrial signal.

15. The method of claim 13, wherein the mobile device is a digital mobile television.

16. The method of claim 15, wherein the dialog messages correspond to digital television functions.

17. The method of claim 13, wherein at least one of the dialog messages is represented by at least one of an icon and a text string.

18. The method of claim 17, wherein various ones of the dialog messages are differentiated based on various purposes, the various purposes being represented by various displayed icons.

19. The method of claim 13, wherein at least one of the dialog messages at least one of indicates a current operating condition to a user of the mobile device or requests an input from the user regarding the current operating condition.

20. The method of claim 13, wherein at least one of the dialog messages relates to at least one of an initialization of the mobile device, an absence of a requested service, an absence of a signal, an absence of a selected program, an out-of-network condition, an available upgrade to the mobile device, a download status, and a request for user action relating to an operation of the mobile device.

21. The method of claim 13, wherein at least one of the dialog messages relates to informing a user of a current undesired status of a digital television function and at least another one of the dialog messages relates to informing the user of a user action for changing the current undesired status back to a previous desired status.

22. The method of claim 13, wherein at least one of the dialog messages is configured for display at least one of over a pre-specified time period and until a pre-specified condition has occurred.

23. The method of claim 22, wherein the pre-specified condition comprises a receipt of a user input.

24. The method of claim 13, wherein at least one of the dialog messages is configured for display over an existing image, a particular image dedicated for use with the at least one of the dialog messages, a fixed image, and a dynamic image.
